(19) United States
(12) Patent Application Publication
(10) Pub. No.: US 2013/0291347 A1
(43) Pub. Date: Nov. 7, 2013

(54) BELT BUCKLE WITH A MAGNETIC ATTRACTION SURFACE MADE IN SIMPLE FABRICATION

(71) Applicant: Yung-Fa SU, Kaohsiung City (TW)

(72) Inventor: Yung-Fa SU, Kaohsiung City (TW)

(21) Appl. No.: 13/461,357

(22) Filed: May 1, 2012

(51) Int. Cl. H01F 7/02; A44B 11/00

(52) U.S. Cl. 24/303

(57) ABSTRACT

A belt buckle with a magnetic attraction surface made in simple fabrication is made of a magnetic metal material and has an indented holding trough on a surface with at least one upward opening. The holding trough has a magnetic attraction surface on an inner end surface and two side walls at two sides thereof. The holding trough holds an ornamental article which has at least one magnet located thereon to be attracted to the magnetic attraction surface. The magnetic attraction surface can attract various types of ornamental articles formed in irregular shapes. When the ornamental article includes a plurality of magnets to form multiple magnetic attraction spots, it can be easily and securely attracted to the magnetic attraction surface. As the holding trough can be formed by stamping once, fabrication process is simpler, thus can reduce production time and cost and improve practicality and usability.

### FIELD OF THE INVENTION

The present invention relates to a belt buckle and particularly to a belt buckle with a magnetic attraction surface that can be simply fabricated in diversified profiles.

### BACKGROUND OF THE INVENTION

A conventional belt generally aims to hold trousers securely without dropping and does not provide other functions. Nowadays consumers are more capricious and often demand multifunction for many personal goods. The belt designed and made in the conventional style does not incite much purchase desire from consumers. New structures are needed to improve its functionality.

To remedy the aforesaid shortcoming, many different types of belt buckles have been developed and introduced on the market. FIG. 1 illustrates one of them in which the belt buckle 1 has a protrusive wall 11 at one side with a notch directing outwards and a slide groove 111 formed in the middle. The slide groove 111 holds a first magnet 112 to attract a marker 12 which is located at a bottom of a second magnet 121. Such a design makes removing the marker 12 easier. But the marker 12 is easily moved transversely when subject to an external force. As the slide groove 111 has a free opening without any barrier, the marker 12 easily loosens off and gets lost.

FIG. 2 shows another type of the belt buckle disclosed in U.S. Pat. No. 3,155,236. It mainly has a non-through orifice 21 at one end surface of the belt buckle 2, an indented notch 22 at the upper side and a slot 23 on the notch 22 leading to the orifice 21. The slot 23 holds an emblem 24 corresponding to the orifice 21. It also has a cap 25 insertable into the slot 23 to securely hold the emblem 24. When removing the emblem 24 is desired the cap 25 has to be removed first. It is troublesome in use. Moreover, fabrication of the belt buckle 2 also involves more complicated process.

FIG. 3 depicts U.S. Pat. No. 6,886,724 which mainly includes a belt buckle 3 with a recess 31 formed at one end surface and a plurality of fixed magnets 32 located on the peripheral sides of the recess 31. It also has a wedged article 33 with other magnets 331 to attract to the fixed magnets 32 so that the wedged article 33 can be securely held in the recess 31. Such a design requires the profile of the wedged article 33 to match the shape of the recess 31, and the profile of the wedged article 33 cannot be changed flexibly as desired. Moreover, the locations of the magnets 32 and 331 must be aligned with each other to get the desired attraction. Hence it creates a lot of inconveniences when in use.

While the attracted article such as an emblem or wedged article can be arbitrarily removed from or attracted to the aforesaid conventional belt buckles, the belt buckle and attracted article must have mating magnetic attraction spots, but the profile of the attracted article is constrained by the belt buckle. In the event that other types of the attracted articles have to be changed as desired, since the magnetic attraction spots do not match, the belt buckle also has to be changed at the same time to achieve stable attraction. Hence usability suffers, and an extra burden of purchase also incurs to consumers. There are still rooms for improvement.

### SUMMARY OF THE INVENTION

In view of the aforesaid problems, the present invention aims to provide a belt buckle with a magnetic attraction surface made in simple fabrication to overcome the disadvantages of the conventional belt buckles. The present invention is an improvement of U.S. Pat. No. 7,784,655 entitled “Belt buckle” and U.S. publication No. US20110167597 entitled “Multifunctional belt buckle” that were proposed by the Inventor. The invention provides a simple fabrication process for making a belt buckle to overcome the disadvantages of the structural design of the conventional belt buckles and enhance fabrication efficiency and also improve usability.

To achieve the foregoing object, the belt buckle according to the invention is made of a magnetic metal material by stamping once to form an indented holding trough on a surface with at least one upward opening. The holding trough has a magnetic attraction surface on an inner end surface and two side walls at two sides thereof. The holding trough holds an ornamental article which has at least one magnet located on the surface thereof to be attracted to the magnetic attraction surface.

In another aspect, the belt buckle may also be made of a non-magnetic material, and the holding trough of the belt buckle has an indented recess on one end surface to include an attraction layer made of a magnetic material to attract the ornamental article.

By means of the technique set forth above, compared with the conventional techniques, the invention provides many advantages, notably:

1. The belt buckle is made of a magnetic metal material and the holding trough is formed by stamping, hence fabrication is simpler and production process and time can be reduced to save production cost.

2. The magnetic attraction surface in the holding trough is a flat surface which can mate various types of ornamental articles formed in irregular shapes. As long as the magnet is positioned at a desired location on the surface of the ornamental article, it can be easily and securely attracted to the magnetic attraction surface. Hence the belt buckle can attract diversified ornamental articles to overcome the constraint of the magnetic attraction spots in the conventional belt buckles that results in monotonous profile of the ornamental article. Through the magnetic attraction surface the ornamental article can be changed in different shapes as desired to suit different occasions and requirements. Practicality improves, and the belt buckle thus made also provides more added values.

3. The holding trough has the upward opening that is a more ergonomic design and allows the ornamental article to be removed and mounted easily, hence usability also improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional belt buckle in a use condition.

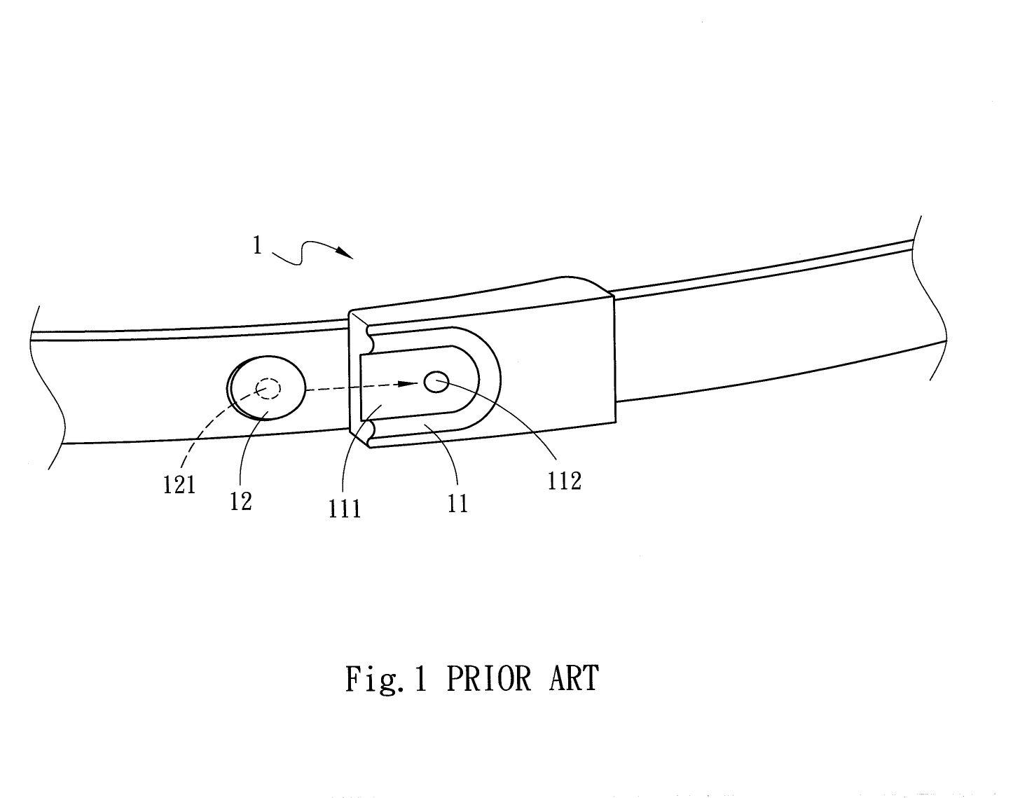

FIG. 2 is a schematic view of a belt buckle according to U.S. Pat. No. 3,155,236.

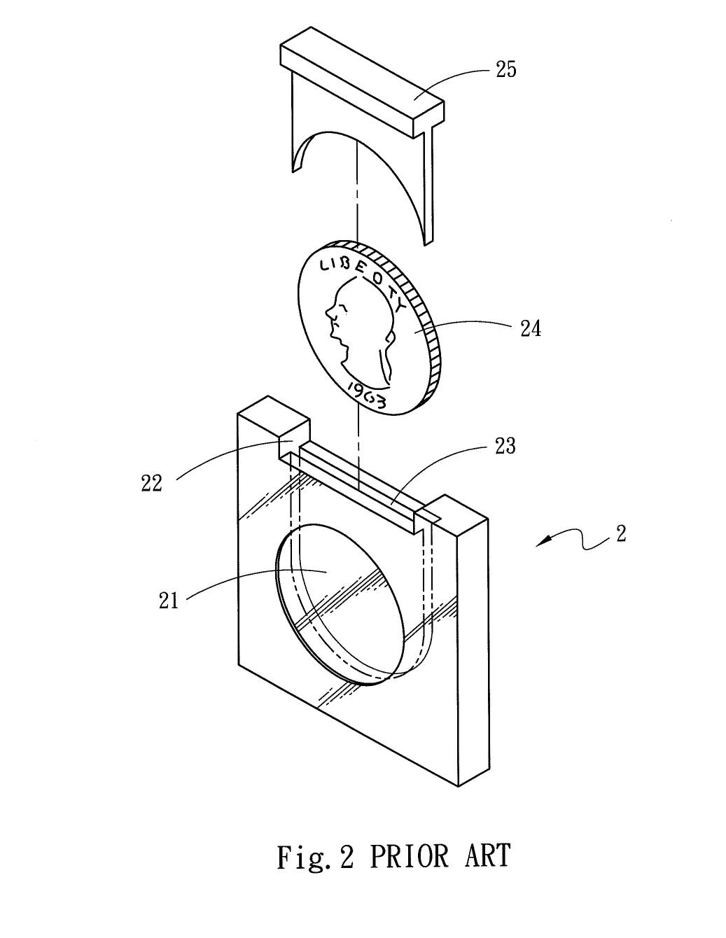

FIG. 3 is a schematic view of a belt buckle according to U.S. Pat. No. 6,886,724.

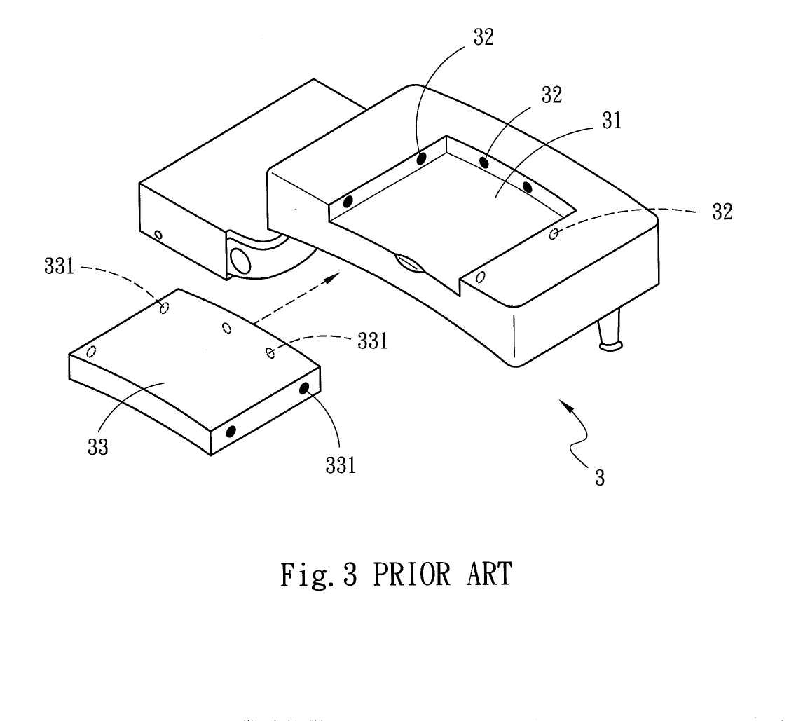

FIG. 4 is a schematic view of a first embodiment of the invention in a use condition.

FIG. 5 is a schematic side view according to FIG. 4.

FIG. 6 is a cross section of the belt buckle of the invention.

FIG. 7 is a schematic view of an ornamental article designed in various profiles.

FIG. 8 is a schematic view of a second embodiment of the invention.

FIG. 9 is a schematic view of a third embodiment of the invention in a use condition.

### DETAILED DESCRIPTION OF THE PREFERRED EMBODIMENTS

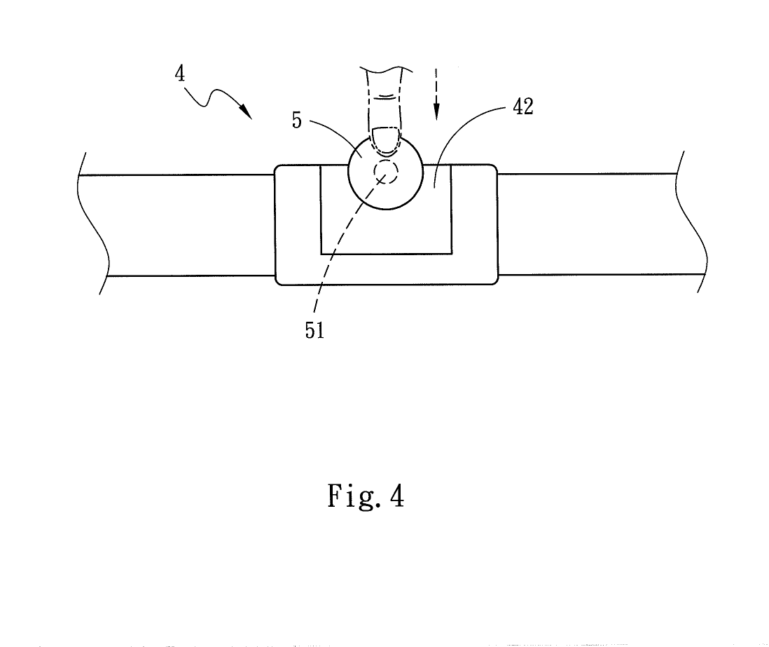

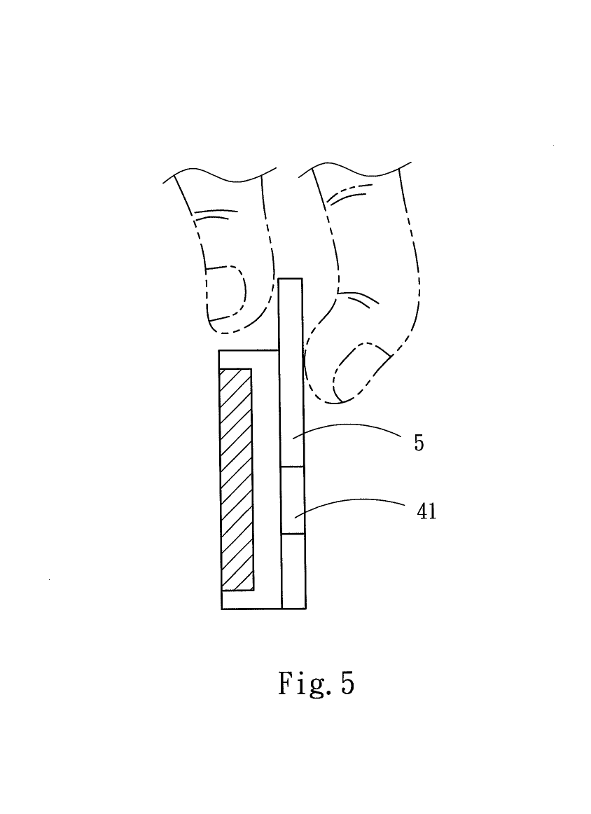

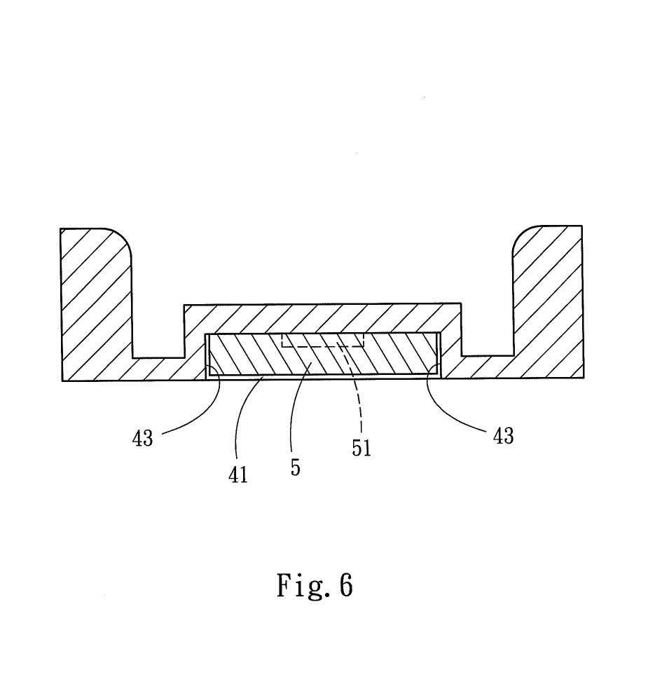

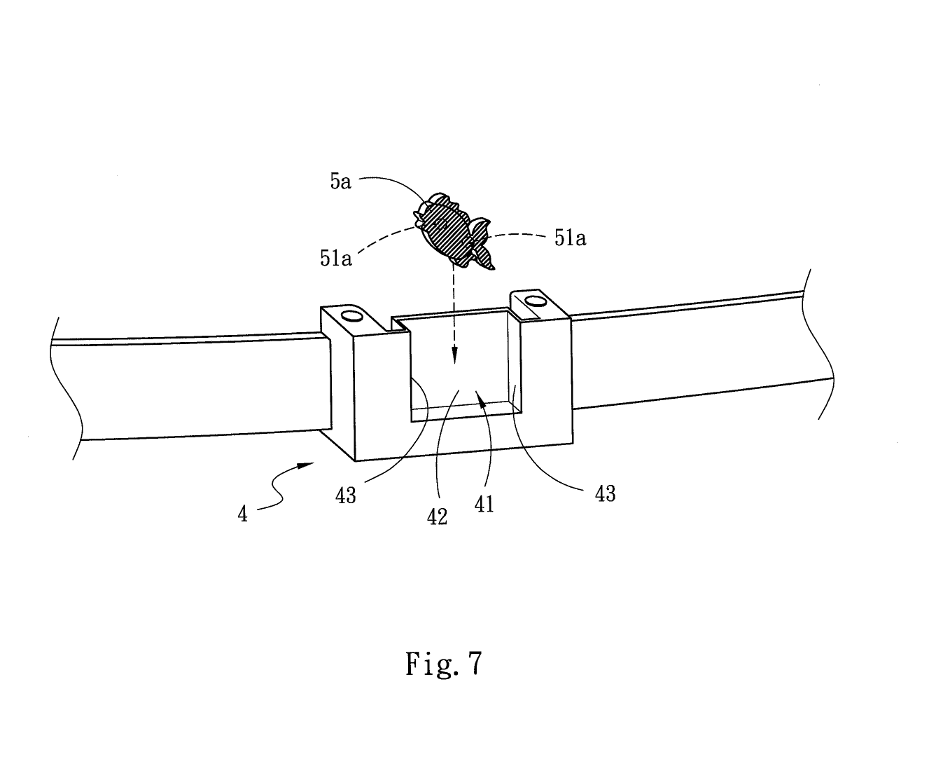

Please refer to FIGS. 4 through 7 for an embodiment of the invention. The belt buckle 4 according to the invention is made of a magnetic metal material and formed by stamping once. It includes an indented holding trough 41 on a surface with at least one upward opening. The holding trough 41 has a magnetic attraction surface 42 on an inner end surface and two side walls 43 at two sides thereof. The holding trough 41 holds an ornamental article 5 which has at least one magnet 51 located thereon to be attracted to the magnetic attraction surface 42. The magnet 51 has a plurality of magnetic attraction spots. When the ornamental article 5 is formed in an irregular shape, the magnet 51 is simply positioned at a desired location on the ornamental article 5 it can be attracted to the magnetic attraction surface 42 due to the balance attraction of the magnetic attraction spots as shown in FIG. 7. The ornamental article 5a can be changed in diversified profile as desired in response to a prevailing fashion trend to be mixed and worn by users as desire, such as irregular shapes of twelve zodiac symbols or constellations commonly seen in astrology, thereby to motivate purchase desire of consumers. Through the magnetic attraction spots formed by the magnets 51a, the ornamental article 5a can be securely attracted to the magnetic attraction surface 42. It offers function and effect not achievable by the conventional belt buckles.

When the invention is in use, the ornamental article 5 can be removed by pushing upwards via a user's thumb, and the ornamental article 5 can be attached to any location of the magnetic attraction surface 42. Use and disposal is simple. Removing up or down vertically also conforms to ergonomic principle without causing fatigue on user's wrist. When the user is engaged in sport activities, the side walls 43 of the holding trough 41 can securely hold the ornamental article 5 inside from dropping. Moreover, as the ornamental article 5 can be made in diversified profiles, it also can be made in a round shape to serve as a token to substitute a coin to be used on hand carts in shopping malls, or a ball marker on the golf courses to provide various functions.

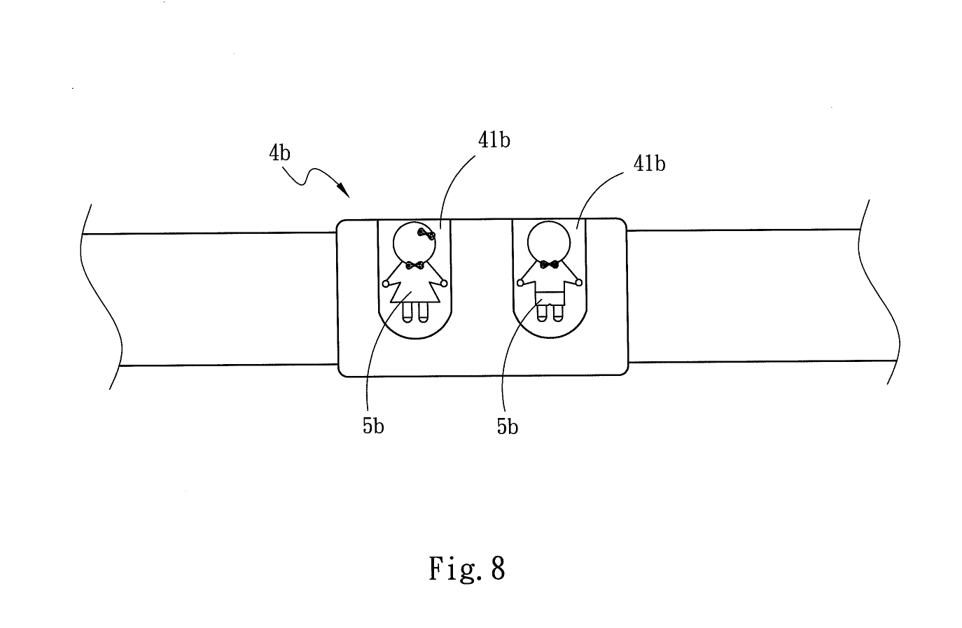

Please refer to FIG. 8 for a second embodiment of the invention. The belt buckle 4b has two holding troughs 41b to hold different types of ornamental articles 5b to enhance aesthetic appeal and novelty.

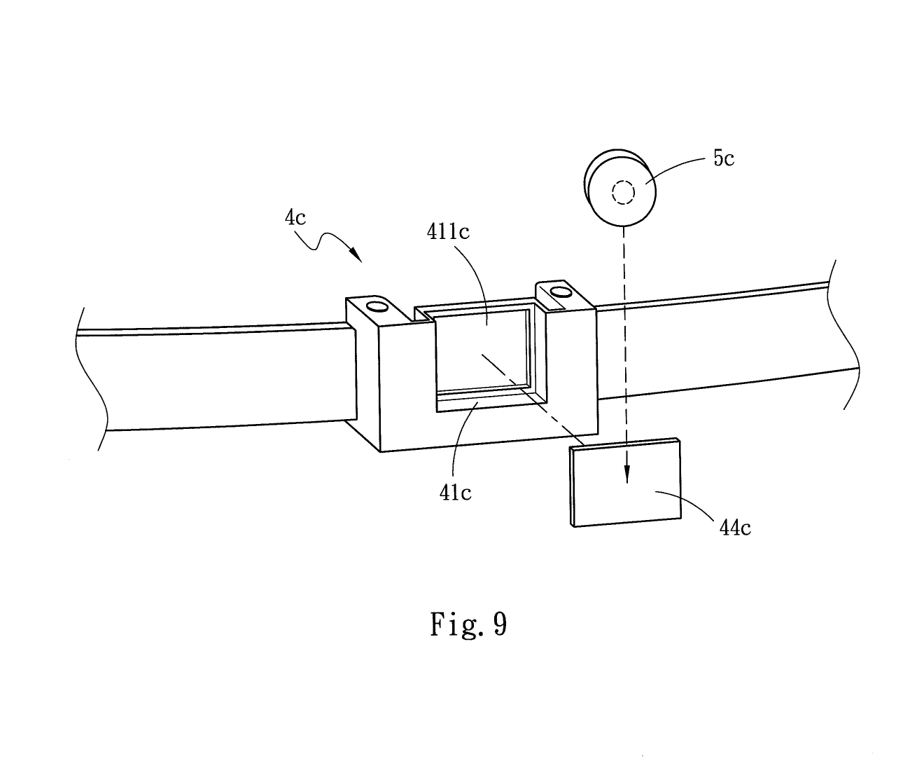

Please refer to FIG. 9 for a third embodiment of the invention. The belt buckle 4c may also be made of a non-magnetic material and formed via an injection process. It has features as follow: the holding trough 41c has an indented recess 411c formed on an inner end surface thereof. The recess 411c has an attraction layer 44c made of a magnetic material and formed in a flat surface to facilitate attraction of the ornamental article 5c. Therefore, the ornamental article 5c can be easily attracted to the belt buckle without constraint in terms of shape or attracted location. The belt buckle thus made also can enhance aesthetic appeal and improve usability.

As a conclusion, the belt buckle with a magnetic attraction surface made in simple fabrication according to the invention provides improved attraction effect over the conventional techniques.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A belt buckle with a magnetic attraction surface made in simple fabrication and made of a magnetic metal material, comprising a holding trough indented from a surface, the holding trough including at least one upward opening, a magnetic attraction surface on an inner end surface and two side walls at two sides thereof, the holding trough holding an ornamental article which includes at least one magnet on one surface thereof to be attracted to the magnetic attraction surface of the holding trough.

2. A belt buckle with a magnetic attraction surface made in simple fabrication and made of a non-magnetic material, comprising a holding trough indented from a surface, the holding trough including at least one upward opening, a recess on an inner end surface to include an attraction layer made of a magnetic material and two side walls at two sides thereof, the holding trough holding an ornamental article which includes at least one magnet on one surface thereof to be attracted to the attraction layer.
